(19) United States
(12) Patent Application Publication
(10) Pub. No.: US 2014/0117795 A1
(43) Pub. Date: May 1, 2014

(54) MOTOR COOLING FEATURES

(71) Applicant: REMY TECHNOLOGIES, LLC, Pendleton, IN (US)

(72) Inventor: Paul Martin Dedrich, Auburn, IN (US)

(73) Assignee: REMY TECHNOLOGIES, LLC, Pendleton, IN (US)

(21) Appl. No.: 13/666,724

(22) Filed: Nov. 1, 2012

(51) Int. Cl. H02K 9/19

(52) U.S. Cl. 310/54

(57) ABSTRACT

A cooling system of an electric machine includes a rotor having a shaft, a hub mounted to the shaft, and a core mounted to the hub. A bearing assembly is secured to the shaft and has a rotating portion and a fixed portion including a fluid inlet. A plurality of nozzle features are fluidly connected to the fluid inlet via a manifold. A cooling system of an electric machine includes a rotor having a shaft and a hub mounted to the shaft, a fluid inlet having a rotating portion and having a fixed portion, a fluid manifold, and a plurality of nozzle features disposed in the hub and fluidly connected to the fluid inlet via the manifold. A method of cooling an electric machine includes spraying coolant from a plurality of hub nozzles onto end turns of a stator winding.

### BACKGROUND

The present invention is directed to improving the performance and efficiency of electric machines and, more particularly, to a spray cooling system.

An electric machine is generally structured for operation as a motor and/or a generator, and may have electrical windings, for example in a rotor and/or in a stator. Such windings may include conductor wire formed as solid conductor segments or bars that are shaped to be securely held within a core, bobbin, or other structure. The conductors may be formed of copper, aluminum, or other electrically conductive material by various manufacturing operations, including casting, forging, welding, bending, heat treating, coating, jacketing, or other appropriate processes. Such conductors are typically formed as individual segments that are assembled into a stator and then welded together.

The stator has a cylindrical core that secures the conductor segments of the stator windings in slots disposed around the circumference of the core. In many electric machines, the stator core is densely populated so that each angular position has several layers of conductor segments installed therein. In a densely packed stator operating at a high performance level, excessive heat may be generated in the stator windings. In some applications, heat must be actively removed to prevent it from reaching impermissible levels that may cause damage and/or reduction in performance or life of the motor. Various apparatus and methods are known for removing heat. One exemplary method includes providing the electric machine with a water jacket having fluid passages through which a cooling liquid, such as water, may be circulated to remove heat. Another exemplary method may include providing an air flow, which may be assisted with a fan, through or across the electric machine to promote cooling. A further exemplary method may include spraying or otherwise directing oil or other coolant directly onto end turns of a stator.

Rotors of electric machines may include windings, axially extending induction bars, and/or permanent magnets that generate heat. Friction, eddy currents, hysteresis losses, and other aspects of machine operation also generate heat. Such heat may cause lowering of machine efficiency and output, and excessive heat may result in physical damage and mechanical problems. For example, in internal permanent magnet (IPM) rotors, the magnets are sensitive to heat and will de-magnetize when subjected to excessive heat generated from power losses in the motor.

Conventional electric machines are not adequately cooled. Although various structures and methods have been employed for cooling an electric machine, improvement remains desirable.

### SUMMARY

It is therefore desirable to obviate the above-mentioned disadvantages by providing a structure and method for spraying coolant onto stator end turns.

According to an exemplary embodiment, a cooling system of an electric machine includes a rotor having a shaft, a hub mounted to the shaft, and a core mounted to the hub. A bearing assembly is secured to the shaft and has a rotating portion and a fixed portion including a fluid inlet. A plurality of nozzle features are fluidly connected to the fluid inlet via a manifold.

According to another exemplary embodiment, a cooling system of an electric machine includes a rotor having a shaft and a hub mounted to the shaft, a fluid inlet having a rotating portion and having a fixed portion, a fluid manifold, and a plurality of nozzle features disposed in the hub and fluidly connected to the fluid inlet via the manifold.

According to a further exemplary embodiment, a method of cooling an electric machine includes spraying coolant from a plurality of hub nozzles onto end turns of a stator winding.

The foregoing summary does not limit the invention, which is defined by the attached claims. Similarly, neither the Title nor the Abstract is to be taken as limiting in any way the scope of the claimed invention.

### BRIEF DESCRIPTION OF THE DRAWING FIGURES

The above-mentioned aspects of exemplary embodiments will become more apparent and will be better understood by reference to the following description of the embodiments taken in conjunction with the accompanying drawings, wherein:

FIG. 1 is a schematic view of an electric machine;

FIG. 2 is a perspective view of an exemplary rotor assembly;

FIG. 3 is a cross-sectional schematic view of a cooling system of an electric machine, according to an exemplary embodiment;

FIG. 4 is a schematic elevation view of a portion of an exemplary hub after a series of machining processes;

FIG. 5 is a schematic top view of a nozzle block, according to an exemplary embodiment; and

FIG. 6 is a schematic top view of a rotor assembly, according to an exemplary embodiment.

Corresponding reference characters indicate corresponding or similar parts throughout the several views.

### DETAILED DESCRIPTION

The embodiments described below are not intended to be exhaustive or to limit the invention to the precise forms disclosed. Rather, the embodiments are chosen and described so that others skilled in the art may appreciate and understand the principles and practices of these teachings.

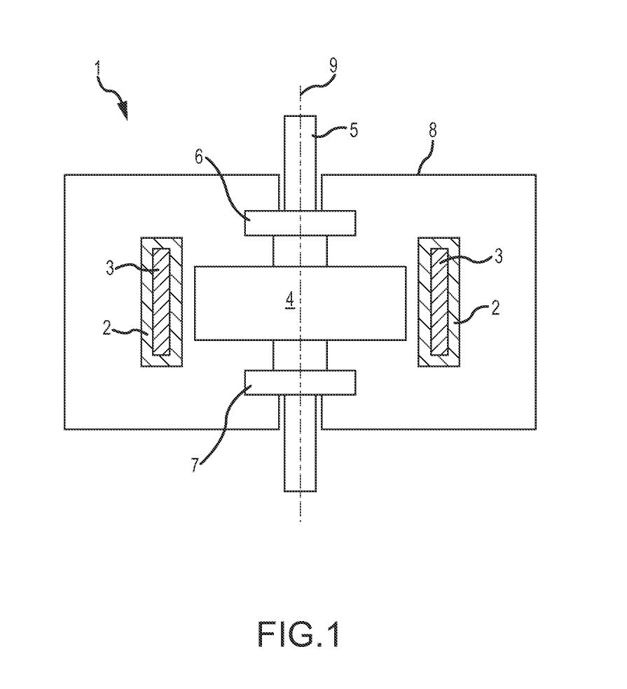

FIG. 1 is a schematic view of an exemplary electric machine 1 having a stator 2 that includes stator windings 3 such as one or more coils. An annular rotor body 4 may also contain windings and/or permanent magnets and/or conductor bars such as those formed by a die-casting process. Rotor body 4 is part of a rotor that includes an output shaft 5 supported by a front bearing assembly 6 and a rear bearing assembly 7. Bearing assemblies 6, 7 are secured to a housing 8. Typically, stator 2 and rotor body 4 are essentially cylindrical in shape and are concentric with a central longitudinal axis 9. Although rotor body 4 is shown radially inward of stator 2, rotor body 4 in various embodiments may alternatively be formed radially outward of stator 2. Electric machine 1 may be an induction motor/generator or other device. In an exemplary embodiment, electric machine 1 may be a traction motor for a hybrid or electric type vehicle. Housing 8 may have a plurality of longitudinally extending fins (not shown) formed to be spaced from one another on a housing external surface for dissipating heat produced in the stator windings 3.

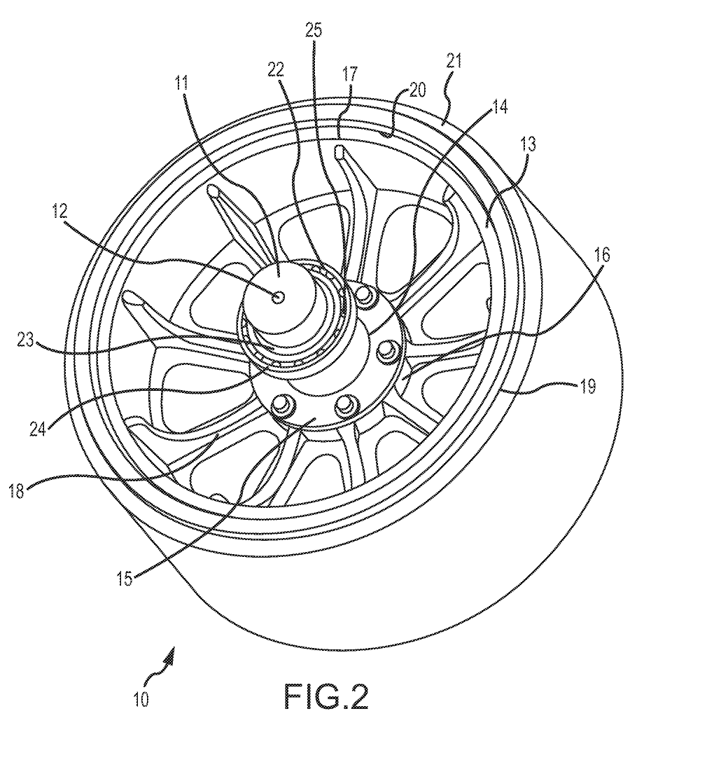

FIG. 2 is a perspective view of an exemplary rotor assembly 10. A shaft 11 may have a center bore 12 that is either threaded or smooth. A hub 13 has a center bore 14 with a diameter slightly larger than the diameter of shaft 11, whereby shaft 11 fits snugly therein and is secured thereto by a compression plate 15. Hub 13 is integrally formed with an inner cylinder 16 and a number of spokes 18 extending radially outward to an outer cylinder 17. The radially outer surface 19 of hub 13 is interference fit to the radially inner surface 20 of a rotor lamination stack 21. A bearing assembly 22 has a rotating inner portion 23 connected to shaft 11, an outer portion 24 connected to a support structure (not shown), and a bearing portion 25 therebetween.

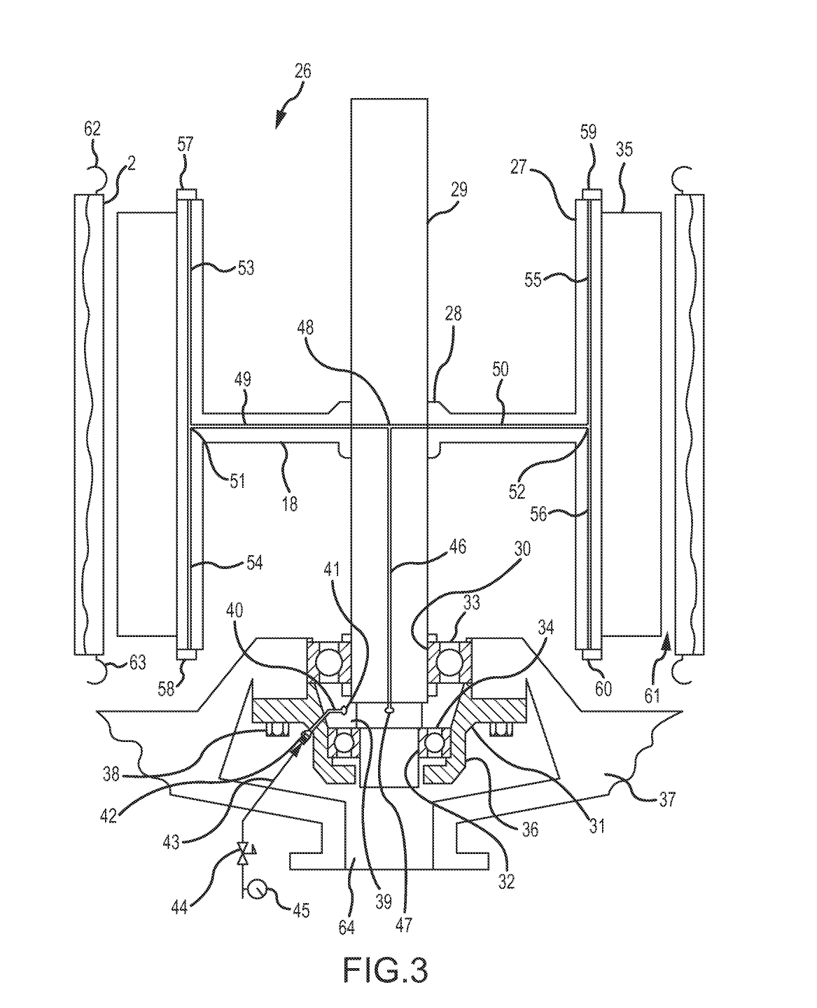

FIG. 3 is a cross-sectional schematic view of a cooling system 26 of an electric machine, according to an exemplary embodiment. A hub 27 has an annular, reinforced inner portion 28 secured to a shaft 29, for example by an interference fit, a compression fit, or by other structure. Hub 27 may be cast, forged, machined, and/or molded of steel, aluminum, resin, or other high strength material. Shaft 29 extends through an annular inner opening 30 of a bearing assembly 31, and is secured thereto by a compression fit, or by other structure such as an interference fit, set screw(s), or other. Shaft 29 further extends through another annular inner opening 32 of bearing assembly 31, and is secured thereto by a compression fit, or by other structure. An axially inward bearing set 33 and an axially outward bearing set 34 allow shaft 29 to rotate. A rotor lamination stack 35 is formed of individual round steel laminations, each coated with an electrical insulation material. Lamination stack 35 is secured to hub 27 by an interference fit, and a keying structure (not shown) is typically also utilized for circumferentially aligning the laminations with one another and with hub 27. The radially outward portions of bearing sets 33, 34 are fixedly secured to a support structure 36 mounted to a frame 37 using bolts 38. Support structure 36 of bearing assembly 31 encloses an annular chamber 39 in the axial space between bearing sets 33, 34. A coolant inlet tube 40 extends through support structure 36 and has a coolant outlet 41 within chamber 39. The other end of coolant inlet tube 40 terminates in a fluid connector 42 secured to support structure 36. A coolant supply line 43 includes one or more valve(s) 44 and flow meter(s) 45, and connects to fluid connector 42. A coolant tube 46 extends longitudinally between an inlet 47, within chamber 39, and a manifold 48. A number of coolant tube sections 49, 50 extend radially along corresponding spokes 18 between manifold 48 and manifolds 51, 52, respectively. Coolant tube 53 extends axially between manifold 51 and nozzle block 57. Coolant tube 54 extends axially between manifold 51 and nozzle block 58. Coolant tube 55 extends axially between manifold 52 and nozzle block 59. Coolant tube 56 extends axially between manifold 52 and nozzle block 60. The coolant tubing may be a light gauge non-magnetic metal, high temperature nylon reinforced plastic, or other material, and typically has an inside diameter of 0.8 to 2 mm. Portions of shaft 29 may include grooves or channels for securing tubing sections 46, 49, 50. For example, a groove may have a circular cross-section. Any imbalance in shaft 29 and the rotor assembly may be easily corrected by manufacturing methods known in the art. An air gap 61 separates the outer circumference of lamination stack 35 from the inner diameter of stator 2. Nozzle blocks 57, 59 are axially aligned with end turns 62, and nozzle blocks 58, 60 are axially aligned with end turns 63. A sump portion 64 is provided for collecting coolant by gravity flow.

In operation, a pump (not shown) provides coolant from a heat exchanger (not shown) to supply line 43. For example, the pump may also supply the coolant to a cooling jacket (not shown) in the body of stator 2. The coolant fills chamber 39 and then fills tubing 46, 49, 50, 53-56. The continued pumping causes the coolant to be discharged from nozzle blocks 57-60. The coolant pressure and the centrifugal force of rotor rotation cause the discharged coolant to spray onto end turns 62, 63 and lamination stack 35. Since the total space of the enclosed coolant paths is small, a pressure of 3-10 psi will typically cause coolant to exit the nozzles with a high force.

Placement of axial coolant channels in hub 27 may be performed by post-casting machining. For example, tubes 53-56 may be formed as longitudinal channels by drilling channels having a diameter of approximately 1.5 mm. Similarly, radially oriented tubes 49, 50 may also be formed as channels by drilling. The use of hub 27 for implementing rotor coolant channels provides advantages compared with conventional channels formed in a rotor lamination core. For example, machining coolant channels into a lamination stack causes electrical shorting therein.

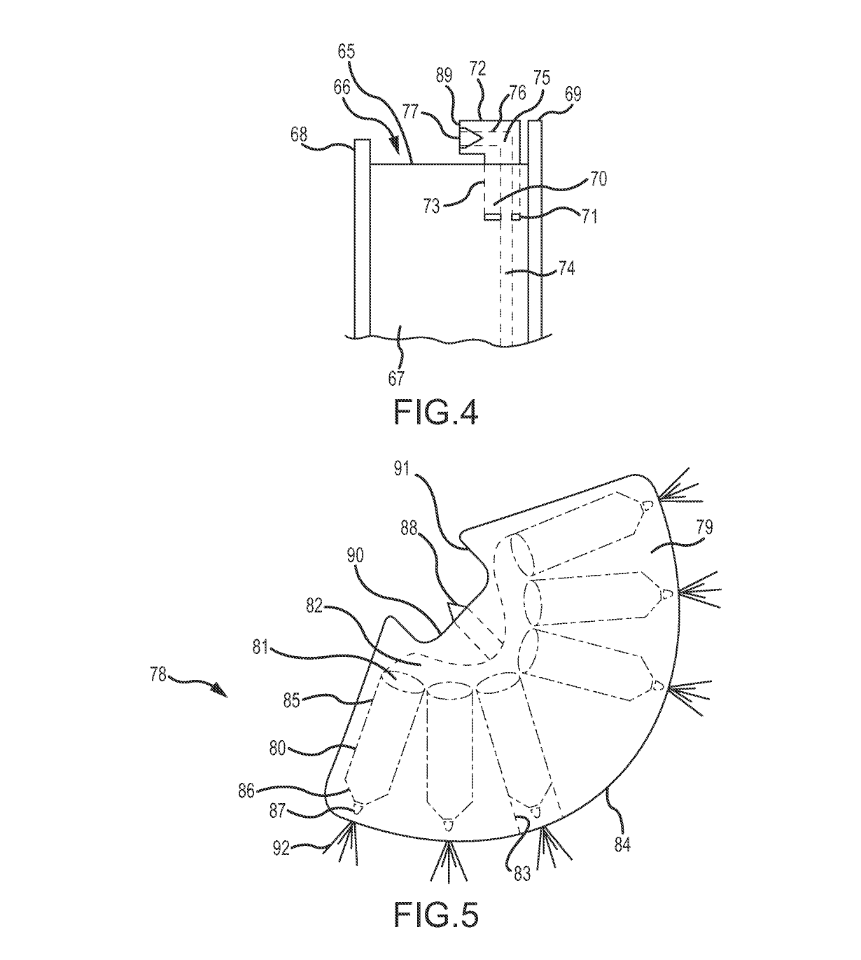

FIG. 4 is a schematic elevation view of a portion of an exemplary hub 67 after a series of machining processes. A cavity 66 is formed at an axial end of hub 67, leaving a radially inner annular wall 68, a radially outer annular wall 69, and an axially facing surface 65. A bore 70 is drilled to a limited depth below surface 65. For example, bore 70 may be drilled and tapped to receive a 6 mm thread. An O-ring 71 or other sealing structure may be placed at a location within bore 70. An exemplary hub adapter 72 has a threaded insert portion 73 that screws into the threaded portion of bore 70. When adapter 72 is screwed in and properly seated, fluid channel 75 of adapter 72 is aligned with fluid channel 74 of hub 67, and the fluid connection is sealed by O-ring 71. Fluid channel 75 has a radially extending portion 76 with a fluid connector 77 that faces radially outward.

FIG. 5 is a schematic top view of an exemplary nozzle block 78, according to an exemplary embodiment. A body 79 may be formed by casting or by other processing appropriate for the chosen body material, such as metal. Nozzle block 78 is formed to fit within cavity 66 and rest atop axial end surface 65 (FIG. 4). Individual nozzles 80 are positioned to have a rear opening 81 in communication with a manifold portion 82 common to rear openings 81 of all nozzles 80 of block 78. Nozzles 80 may be formed in any of several different ways. For example, a bore 83 may be machined from either a side of manifold 82 or from an external surface 84, and then a pre-formed nozzle may be installed and secured such as by threads, epoxy, or other structure. In an alternative embodiment, nozzle 80 may be formed by a fine machining process after a wide diameter portion 85 has been cast; a tapered throat portion 86 and a small diameter tip 87 may be formed by precision machining. Alternatively, small diameter needle tips (not shown) may be installed after the casting process and secured by press fitting, threads, or by other structure. A fluid connector 88 extends from manifold 82 for mating with fluid connector 77 of FIG. 4. When connectors 77, 88 are properly mated and nozzle block 78 is seated on surface 65 of hub 67, the radially outward surface 89 of hub adapter 72 is contiguous with surface 90 of nozzle block 78 and adapter 72 fits within nozzle block slot 91.

Surface 84 of nozzle block 78 may be formed as any number of individual surfaces. For example, a first set of nozzles 80 may be referenced from a first surface and a second set of nozzles 80 may be referenced from a second surface. In a case where three nozzles 80 form a set and a center nozzle 80 is referenced, each other nozzle 80 may be angled away from center by 0-45 degrees. The amount of angling may depend on the force, volume, width, elevation, coverage and other parameters of the spray 92 from each nozzle 80 or from sets thereof. Horizontal and vertical spacing and elevation of individual nozzles 80 may be varied as required for providing optimum cooling of stator end turns 62, 63.

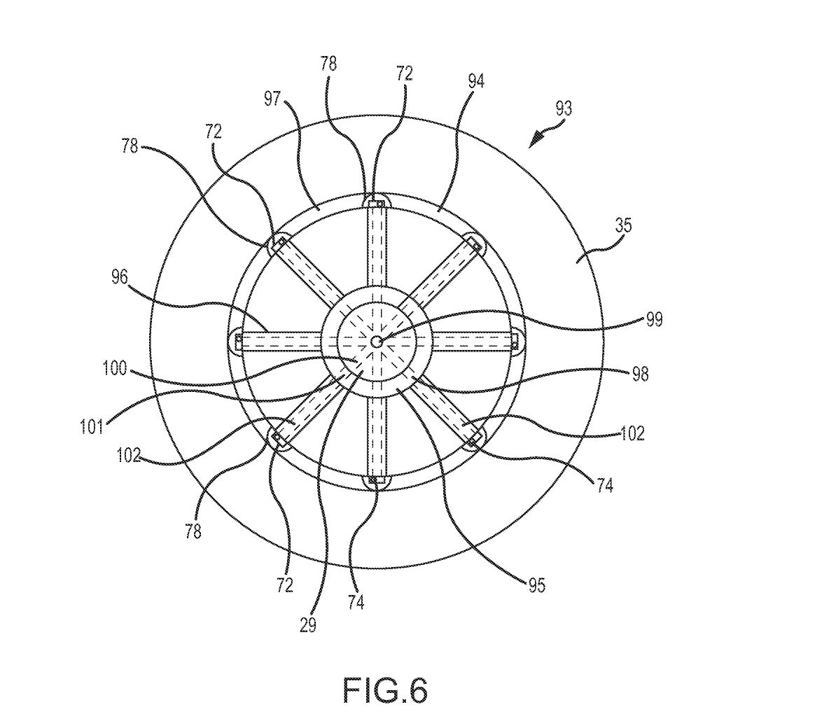

FIG. 6 is a schematic top view of a rotor assembly 93, according to an exemplary embodiment. Lamination stack 35 is secured to hub 94. Hub 94 has an annular inner shaft attachment portion 95, spokes 96, and an outer rim portion 97. Radially extending fluid channels 98 are in fluid communication with an axial fluid channel 99 at the center of shaft 29. Radial channels 98 pass through radially extending bores 100 formed in shaft 29. Each bore 100 is mated to a respective inner channel portion 101 and a spoke channel 102. Each spoke channel 102 feeds an axially extending bore/tube 74 in fluid communication with a passageway 75 formed in adapter 72 (FIG. 4). Each adapter 72 is mated with a respective nozzle block 78. Sizes of channels and bores, for example, may be 0.5 to 1.5 mm or any other appropriate diameter.

In operation, the relatively small sizes of fluid paths within rotor assembly 93 assures that coolant being ejected through nozzles 80 of nozzle blocks 78 has acceptable velocity to produce spray 92 (FIG. 5) that travels past lamination stack 35 and impacts stator end turns 62, 63 (FIG. 3). Nozzle angle and elevation are typically set to maximize and focus sprays 92 on stator end turns 62, 63. Overspray and other coolant being ejected from nozzles 80 typically also impacts the body of stator 2, lamination stack 35, and portions of hub 27 (FIG. 3), thereby providing ancillary cooling of other portions of electric machine 1. Depending upon the particular application, the high spray velocity created by use of small diameter channels/tubing may be balanced with a need to maximize coolant flow volume. For example, any nozzle channels may have an increased size without compromising structural integrity. Axial channel/tube 46 and manifold 48 of shaft 29, and radial channels 100, 101 may have an increased size when material strength and rigidity are not thereby rendered insufficient.

Various types of nozzles 80 may be used, such as cone pattern spray nozzles, fan pattern spray nozzles or needle jet nozzles. A jet is a substantially continuous column of moving liquid, in contrast to a spray which is formed from discrete droplets. Nozzles 80 may differ according to their relative positions respecting one another. For example, nozzles 80 may be declined, inclined, leading, trailing, or central. The location of nozzles 80 may also be varied to the extent that the sprays or jets from the nozzles do not excessively interfere with each other. Nozzles 80 may produce spray 92 as a coherent stream having a high peak impact force on end turns 62, 63, or nozzles 80 may be structured to provide spray 92 that expands and disperses into any degree of fine droplets.

While various embodiments incorporating the present invention have been described in detail, further modifications and adaptations of the invention may occur to those skilled in the art. However, it is to be expressly understood that such modifications and adaptations are within the spirit and scope of the present invention.

What is claimed is:

1. A cooling system of an electric machine, comprising:
a rotor having a shaft, a hub mounted to the shaft, and a core mounted to the hub;
a bearing assembly secured to the shaft, the bearing assembly having a rotating portion and having a fixed portion including a fluid inlet;
a fluid manifold; and
a plurality of nozzle features fluidly connected to the fluid inlet via the manifold.

2. The cooling system of claim 1, wherein the fluid manifold is disposed in the rotating portion of the bearing assembly.

3. The cooling system of claim 1, wherein the fluid manifold is disposed in the hub.

4. The cooling system of claim 1, wherein the nozzle features are formed as a plurality of blocks each having at least one exposed nozzle surface having at least one fluid ejection bore.

5. The cooling system of claim 4, wherein at least one of the blocks includes a nozzle array having a manifold.

6. The cooling system of claim 5, wherein the hub comprises an axial coolant channel, the system further comprising a hub adapter for fluidly connecting the nozzle array manifold to the coolant channel.

7. The cooling system of claim 4, wherein the fluid manifold comprises a plurality of manifolds disposed in respective ones of the blocks.

8. The cooling system of claim 4, wherein at least one of the blocks comprises a nozzle slot and a nozzle insertable therein.

9. The cooling system of claim 1, further comprising a valve disposed in the bearing assembly for transferring coolant from the fixed portion to the rotating portion.

10. The cooling system of claim 1, wherein the hub includes longitudinal channels fluidly connected to the nozzle features.

11. The cooling system of claim 1, wherein the nozzle features are formed in the hub.

12. A cooling system of an electric machine, comprising:
a rotor having a shaft and a hub mounted to the shaft;
a fluid inlet having a rotating portion and having a fixed portion;
a fluid manifold; and
a plurality of nozzle features disposed in the hub and fluidly connected to the fluid inlet via the manifold.

13. The cooling system of claim 12, wherein the nozzle features are formed as a plurality of blocks each having at least one exposed nozzle surface having at least one fluid ejection bore.

14. The cooling system of claim 13, wherein at least one of the blocks includes a nozzle array having a manifold.

15. The cooling system of claim 14, wherein the hub comprises an axial coolant channel, the system further comprising a hub adapter for fluidly connecting the nozzle array manifold to the coolant channel.

16. The cooling system of claim 13, wherein at least one of the blocks comprises a nozzle slot and a nozzle insertable therein.

17. A method of cooling an electric machine, comprising spraying coolant from a plurality of hub nozzles onto end turns of a stator winding.

18. The method of claim 17, further comprising flowing the coolant through an axial channel of a shaft.

19. The method of claim 17, further comprising flowing the coolant through an axial channel of a hub.

20. The method of claim 17, wherein the flowing of coolant comprises urging the coolant through a plurality of axial hub channels.
